(19) United States
(12) Patent Application Publication
(10) Pub. No.: US 2013/0298883 A1
(43) Pub. Date: Nov. 14, 2013

(54) MOTOR VEHICLE COMPRISING A RECIRCULATED-GAS CIRCUIT AND METHOD FOR IMPLEMENTING SAME

(71) Applicants: Pascal Archer, Courbevoie (FR); Cedric Rouaud, Hove (GB); Julien Metayer, Le Chesnay (FR)

(72) Inventors: Pascal Archer, Courbevoie (FR); Cedric Rouaud, Hove (GB); Julien Metayer, Le Chesnay (FR)

(73) Assignee: RENAULT S.A.S., Boulogne Billancourt (FR)

(21) Appl. No.: 12/746,610

(22) PCT Filed: Nov. 18, 2008
(86) PCT No.: PCT/EP08/65716

§ 371 Date: Dec. 22, 2010

(30) Foreign Application Priority Data
Dec. 5, 2007 (FR) 07/08497

(51) Int. Cl. F02M 25/07

(52) U.S. Cl. CPC F02M 25/0727
USPC 123/568.12

(57) ABSTRACT

In a motor vehicle having exhaust-gas recirculation, fluid of an air-conditioning circuit is used to cool coolant of a dedicated hydraulic circuit, which in turn cools recirculated exhaust gases in a two-stage heat exchanger, thus increasing engine gain by replenishing to reduce NOx emissions. A method differentiates control strategies for the circuits, as a function of vehicle driving conditions, continuous modes and transient braking and acceleration modes, to compensate for consumption of the compressor of the air-conditioning circuit. The circuits include a heat exchanger for heat exchange between the air-conditioning fluid and coolant, a bypass, capable of accumulating and releasing cold energy, and, optionally, a line condensing water vapour of the exhaust gases and reinjecting the condensed water to the intake.

The present invention relates to the field of motor vehicle engines running on diesel or on gasoline and comprising an exhaust gas recirculation (EGR) circuit.

Environmental constraints relating to the emissions of exhaust gases from an internal combustion engine vehicle, notably an engine of the diesel engine type, are becoming increasingly numerous. Future pollution emissions standards require the use of costly post-treatment systems, notably with a view to reducing the emissions of nitrogen oxides (NOx). Reducing the temperature of the intake gases reduces NOx emissions and therefore makes it possible to dispense with some of the post-treatment systems or, at least, to decrease the catalyst content thereof and therefore the on-cost attributable to the post-treatment.

At the present time the intake gases, that is to say a mixture of fresh air plus recirculated exhaust gases, are often cooled by a radiator at the front end of the vehicle and/or by an exchanger the cold source of which is the combustion engine coolant.

GB 2 394 537 describes a method of cooling circulated exhaust gases using the coolant either leaving the combustion engine cooling radiator or leaving the combustion engine, or a combination of both.

US 2003/0089319 and U.S. Pat. No. 6,668,764 describe circuits for cooling the power train, the recirculated exhaust gases being cooled using the coolant taken as it leaves the combustion engine.

It is also possible to use a dedicated additional cooling circuit with a view to obtaining lower temperatures. EP 1 059 432 describes a system for cooling the circulated exhaust gases using a separate cooling circuit.

EP 1 091 113 describes a cooling circuit with an exchanger for cooling the exhaust gases to 2 temperature levels. However, in that system, cooling is limited by the magnitude of the temperature of the coolant leaving the engine cooling device.

WO 2005/45224 proposes a method for supercooling the intake gases which is assisted by the climate-control loop. The cooling is achieved by direct exchange of heat between the exhaust gases and the refrigerant. This solution does not allow cold to be stored. Document FR 2 890 700, the content of which is incorporated herein by reference, proposes a system for supercooling the intake gases which is assisted by the climate-control loop. The solution uses a secondary water circuit cooled by the air-conditioning system. A gas/water exchanger of the secondary circuit then supercools the intake gases. However, the production of cold by the climate-control loop entails tapping power off the engine, via the alternator or the timing belt, causing an increase in fuel consumption. The solution proposed in that document is not accompanied by control strategies that differ according to the engine speed and has no system for storing cold.

The objective of the invention disclosed here is to reduce the temperature of the intake gases by using the climate-control loop, without leading to additional engine fuel consumption.

The invention proposes control strategies that vary according to the conditions under which the vehicle is being driven, and associated hydraulic circuits.

To this end, the invention proposes a motor vehicle comprising:
an internal combustion engine comprising an exhaust gas recirculation (EGR) circuit, said exhaust gas recirculation circuit comprising a heat exchanger for said recirculated exhaust gases, comprising a high-temperature first stage and a low-temperature second stage,
a first hydraulic circuit for cooling said engine,
a climate-control circuit for air-conditioning the cabin of the vehicle comprising, in a first leg, an evaporator through which a refrigerant circulates,
a second hydraulic circuit for cooling the recirculated gases, comprising a pump driving the coolant of said second hydraulic circuit,
   said high-temperature first stage being located in the first hydraulic cooling circuit and said low-temperature second stage being located in the second hydraulic cooling circuit,
   said vehicle comprising
   a storage heat exchanger allowing an exchange of heat between the coolant of the second hydraulic circuit and the refrigerant of the climate-control circuit,
   the second hydraulic circuit comprising a bypass device allowing the coolant of the second hydraulic circuit to bypass the storage heat exchanger,
   the climate-control circuit comprising a second leg, in parallel with said first leg of the evaporator, allowing the refrigerant to circulate through the storage heat exchanger.

The recirculated exhaust gases can be tapped off upstream of the turbine (in high-pressure EGR) or downstream of the post-treatment systems (in low-pressure EGR).

The bypass device of the second hydraulic cooling circuit may comprise a three-way valve.

The second hydraulic cooling circuit may comprise a radiator for cooling its coolant.

The climate-control circuit may comprise a three-way valve allowing the refrigerant to enter either the first leg or the second leg.

The exhaust gas recirculation circuit may comprise, downstream of the heat exchanger, a phase separator, a liquid reservoir and an injection device capable of reinjecting said liquid into the EGR circuit, at the outlet of a CAC, at the intake manifold, or directly into the combustion chamber. When the liquid is injected into the gas, it evaporates, thus reducing the temperature of the gas.

The climate-control circuit may be a reversible heat pump circuit and comprise a valve for reversing the flow of the fluid, an additional valve connecting the outlet from the combustion engine to the outlet from the radiator of the second hydraulic circuit.

The device according to the invention is implemented at continuous operation vehicle combustion engine speed by controlling the displacement or the rotational speed of the compressor of the climate-control circuit in such a way as to optimize the ratio between the engine better-filling performance enhancement and the consumption.

It is known that when the compressor of a motor vehicle climate-control or air-conditioning system is in operation, it taps power off the engine (crankshaft) via the accessory belt, if the compressor is a mechanical one, or via the alternator if it is an electrical one. By contrast, cooling the intake gases leads to an increase in the power delivered by the engine. This is because the density of the intake gases increases as their temperature decreases. Hence, for the same cylinder volume, the mass of air admitted is greater, thus increasing the power: this phenomenon is known as the engine better-filling performance enhancement.

The present invention uses the climate-control fluid of the vehicle to cool coolant of the hydraulic circuit mentioned above, which in turn cools the recirculated exhaust gases, thus increasing the engine better-filling performance enhancement. There is, on a great many engine operating points, an optimum at which an engine better-filling performance enhancement can be achieved that is equal to or exceeds the power consumed by the climate-control compressor. The principle of continuous control is to adapt the displacement of the compressor, if the compressor is a mechanical one, or the rotational speed thereof if it is an electrical one, in order, at least, to keep these factors in equilibrium.

When there is equilibrium between the better-filling performance enhancement and the consumption of the compressor, the crankshaft delivers the same mechanical power to the gearbox as if the climate-control was switched off, but has a lower intake temperature, this delivers an improvement in NOx reduction or NOx/particulate reduction and in the life of the NOx trap.

When the better-filling performance enhancement is higher than the consumption of the compressor, there are two possible options:
modifying the engine operating parameters in order to reduce its consumption,
accumulating and storing the additional cold for use, for example, when it is not possible to achieve filling/compressor equilibrium.

This control under continuous conditions makes it possible to achieve mechanical equilibrium between the additional consumption due to the compressor and the engine better-filling performance enhancement.

When the engine better-filling performance enhancement exceeds the additional consumption of the compressor, the device according to the invention can be implemented at continuous engine speed by circulating the coolant of the second hydraulic circuit through the bypass of the storage heat exchanger so as to store cold in said storage heat exchanger. This exchanger has to be lagged in order to reduce thermal losses to the hot environment in the engine compartment.

When the engine better-filling performance enhancement exceeds the additional consumption of the compressor, the device according to the invention can be implemented at continuous engine speed by partially condensing the recirculated gases in the low-temperature second stage of the exhaust gas heat exchanger, that is to say by condensing water vapor, separating the liquid phase from the gases, and storing said liquid phase. Storing this liquid water is the equivalent of accumulating cold energy.

The device according to the invention is implemented at combustion engine transient engine speed during vehicle braking operations by maximizing the displacement or the rotational speed of the compressor of the climate-control circuit and by circulating the coolant of the second hydraulic circuit through the bypass of the storage heat exchanger so as to accumulate cold in said storage heat exchanger.

During this phase, the climate-control compressor driven by the crankshaft via the accessories belt transmits a resistive torque (mechanical energy) that slows the rotational speed of the crankshaft and therefore applies braking. The principle of the capacitive control is therefore to store cold in a lagged component by regenerative braking with the climate-control compressor, then to empty this stored cold out during transient phases in which continuous control is not enough or when the thermal demands are too great.

The cold accumulated during the continuous control or during regenerative braking is released when it is not possible to achieve engine better-filling performance enhancements/compressor equilibrium or during an ascending transient involving high thermal demands, and therefore high NOx emissions.

The device according to the invention can be implemented at combustion engine transient engine speed during vehicle accelerations by closing the bypass of the storage heat exchanger and causing the coolant of the second hydraulic circuit to circulate through the storage heat exchanger so as to expel the cold liquid from said storage heat exchanger.

In nominal operation, the heat transfer coolant (glycolated water for example) circulates through the bypass of the storage heat exchanger to cool one or more components lying downstream, a CAC or EGR for example, and regulate the temperature of hot fluids, while a certain mass of non-circulating heat-transfer liquid accumulates cold energy in the storage exchanger.

When the store of cold energy is to be fully or partially emptied, the controlled three-way valve opens. The supercooled stored liquid is then driven by the flow of heat-transfer liquid and passes through the heat exchanger. When the transient is over, the three-way valve closes again and the store is replenished.

The response time of this system is equal to the volume of the heat exchanger divided by the flow rate of heat-transfer fluid, plus the response time of the valve. This response time is far lower than for a conventional system with the thermal inertias of the following components: radiator, water pump, exchanger. This thermal-release phenomenon can therefore be qualified as instantaneous.

Within the context of the claimed invention, the engine/climate-control energy cycle therefore operates like a motor/battery system in the case of a hybrid electric vehicle. This operation can therefore be qualified using the expression “thermal hybridizing”.

The invention will be better understood by those skilled in the art through the detailed description given hereinbelow of a number of embodiments thereof, and from studying the accompanying figures in which:

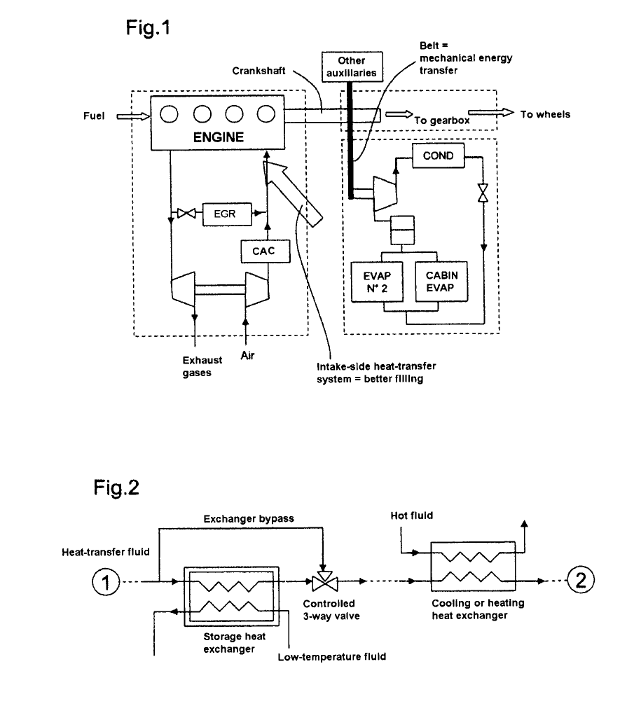

FIG. 1 is a schematic illustrating the control of the device according to the invention in continuous operating mode,

FIG. 2 is a schematic illustrating the operation of the storage heat exchanger,

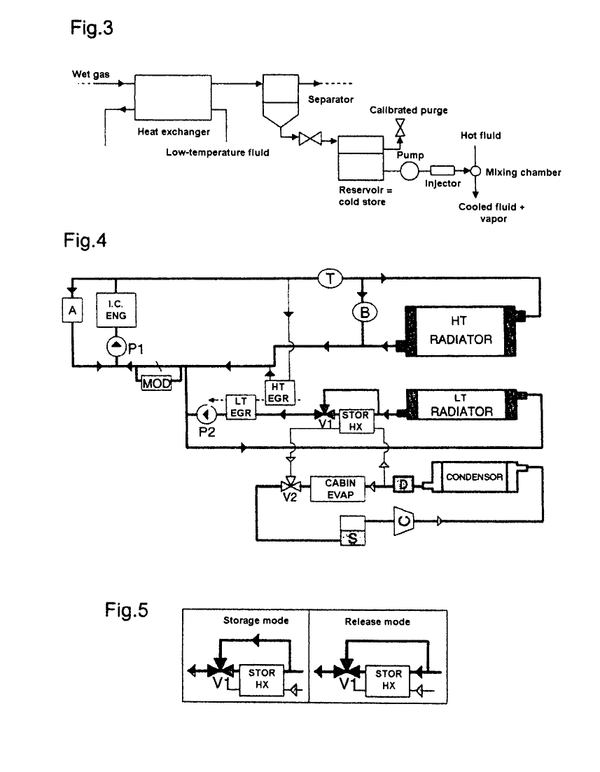

FIG. 3 is a schematic illustrating the partial condensation of the gases and the storage of cold in the form of liquid water,

FIG. 4 is a schematic illustrating a first implementation of the hydraulic circuit according to the invention, in cooling mode,

FIG. 5 is a schematic illustrating the ways of operating the storage heat exchanger,

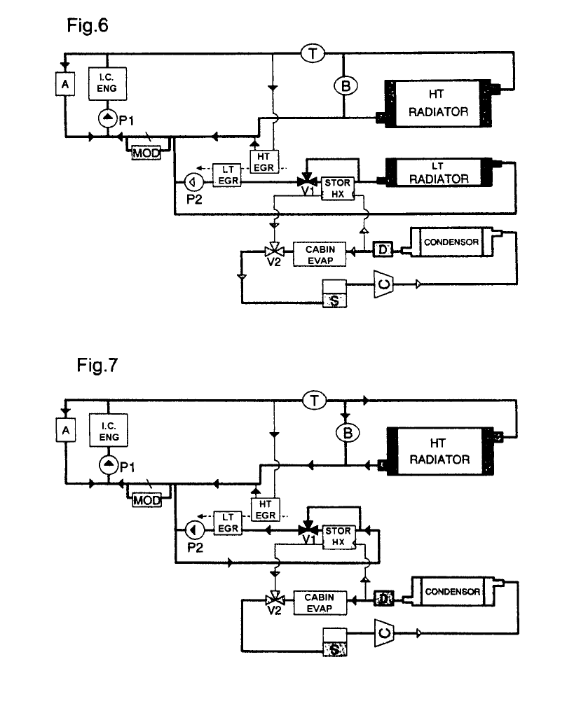

FIG. 6 is a schematic illustrating the hydraulic circuit of FIG. 4, in the mode during which the engine temperature is rising,

FIG. 7 is a schematic illustrating a second implementation of the hydraulic circuit according to the invention,

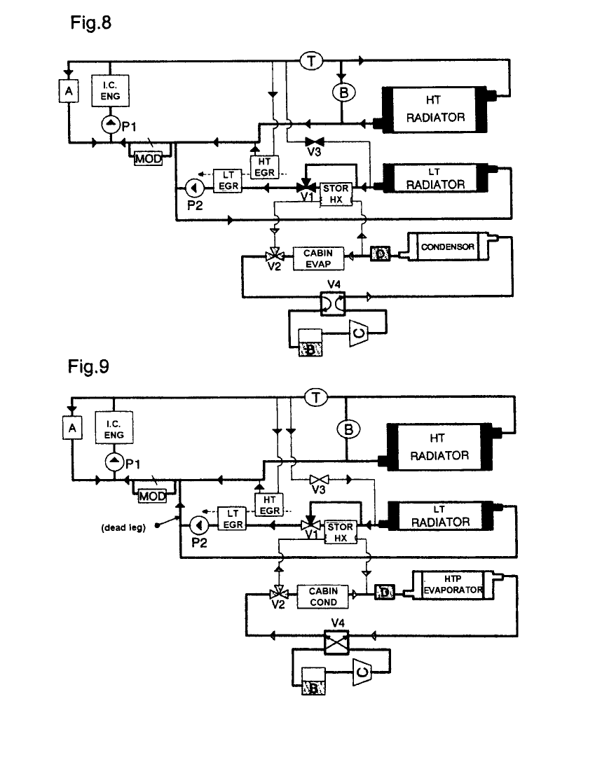

FIG. 8 is a schematic illustrating a third implementation of the hydraulic circuit according to the invention, in cooling mode, and

FIG. 9 is a schematic illustrating the hydraulic circuit of figure eight in increasing-temperature mode.

FIG. 1 illustrates the overall concept underlying the present invention. The left-hand part of FIG. 1 schematically shows the entity consisting of the engine and of the intake gas circuit. The right-hand part of FIG. 1 schematically shows the climate-control circuit. As illustrated by FIG. 1, the invention involves, on the one hand, a transfer of mechanical energy between the engine entity and the climate-control circuit and, on the other hand, a transfer of heat energy between the climate-control circuit and the intake circuit.

The basic hydraulic system, which is illustrated in FIG. 4, consists of three cooling circuits:
a high-temperature first circuit and its HT radiator,
a low-temperature second circuit and its LT radiator,
a climate-control circuit and its condenser (CLIM).

The way in which the radiators and condensers are mounted at the front end of the vehicle may be as follows:
condenser in front of LT radiator in front of HT radiator,
condenser in front of LT radiator under HT radiator,
LT radiator in front of condenser in front of HT radiator,
LT radiator under condenser in front of HT radiator.

The first cooling circuit is made up of conventional components:
a combustion engine: C.I.Eng,
a unit heater: A,
a mechanical water pump P1 driven by the combustion engine (it is also possible to conceive of the use of an electric water pump),
a degassing bottle: B,
a main thermostat: T,
an engine oil cooler MOD.

The second cooling circuit according to the invention comprises:
an electric pump P2,
a two-stage recirculated exhaust gas EGR exchanger (HT EGR and LT EGR) comprising two inlets and two outlets for the coolant, with an inlet and an outlet for the recirculated exhaust gases,
a coolant/refrigerant exchanger (STOR. HX),
a three-way valve V1.

The climate-control circuit is made up of the following conventional components:
a compressor C, either a mechanical one with fixed displacement (alternating on and off), or a mechanical one with a controlled displacement, or a hybrid one, or an electrical one; these compressors make it possible to adjust the production of cold energy to suit the demand, that is to say to cool the cabin and to cool the recirculated exhaust gases,
a condenser,
a reservoir/separator S,
an expander D common to the two legs or one expander in each leg,
an evaporator (CABIN EVAP.).

The climate-control circuit also comprises, according to the invention:
a leg in parallel with the evaporator passing through the refrigerant/coolant exchanger STOR. HX,
a controlled three-way valve V2.

The coolant of the first and second cooling circuits is a conventional mixture of water and ethylene glycol with corrosion inhibitors. The climate-control fluid is a conventional refrigerant (R134a, R152a, CO2, etc.). The climate-control evaporators may be connected in series (because the refrigerant is diphasic, its temperature does not vary).

When the engine is hot, the thermostat T is open and the pump P1 circulates the coolant through the HT radiator. The recirculated (EGR) gases are pre-cooled by the coolant of the HT circuit (500° C.->90° C.) via the HT EGR. They are then supercooled in the LT circuit via the LT EGR. This configuration allows the exchangers to be more compact and allows optimum use of the cooling kit consisting of the HT and LT radiator set.

The filling of the cold store is illustrated in FIGS. 4 and 5: the pump P2 drives the coolant through the LT radiator and the bypass of the storage exchanger STOR. HX. The recirculated gases are then cooled to a temperature close to that of the air entering the LT radiator. During this phase, the liquid enclosed in the storage exchanger is supercooled by the air-conditioning system.

The energy required by the climate-control compressor C can be recuperated during:
vehicle braking or deceleration phases, as described in greater detail hereinbelow,
phases of driving that are stabilized by controlling the engine efficiency/climate-control COP pairing using the on-board processor. Specifically, the efficiency of the engine and the coefficient of performance of the climate control are connected directly to their respective speeds and torques, each of them passing through a maximum efficiency/coefficient of performance at a given engine speed. Using an optimization law, the processor will be able to define the optimum torques of the two systems that will allow fuel consumption to be minimized.

In both instances, the controlled valve V2 allows a cold power in the cabin evaporator to be kept constant (therefore not downgrading comfort levels) by controlling the refrigerant flow rate.

If V1 is a continuous valve, it is then possible to control the flow passing through the exchanger STOR. HX and the flow passing through the bypass simultaneously in “continuous supercooling” mode. Combining of the two flows at the outlet makes it possible to obtain continuous supercooling of the liquid leaving the LT radiator and to control the temperature of the circulated gases.

This function can also be performed by an on/off valve. In both of the abovementioned cases, the valve V1 may be an on/off valve. All that is then required is for all of the flow to be passed through the storage heat exchanger. In such an instance, the temperature of the circulated gases will be controlled by regulating the throughput of the pump P2.

The exchanges of heat between the coolant and the climate-control fluid during the capacitive control phases in transients are illustrated in FIG. 2.

When a vehicle brakes, its kinetic energy is partly dissipated through the brakes. On some vehicles, some of this energy is converted into electrical energy. This involves relieving the workload of the brakes by driving the alternator under braking (stop and start, hybrid electric braking, controlled alternator, regenerative braking, etc.).

The principle of thermal regenerative braking is to convert the kinetic energy into cold energy (or heat energy in the case of a heat pump) during braking phases. During these phases, some of the kinetic energy normally dissipated in the brakes is then used to operate the climate control at full capacity. In material terms this means controlling the displacement in the case of a mechanical compressor or the electronics in the case of an electric compressor. Controlling the displacement of a compressor makes it possible to increase or decrease the mass flow rate of refrigerant, and therefore the power tapped off in the evaporator.

The vehicle wheels then convert the kinetic energy of forward travel of the vehicle into mechanical energy of turning the crankshaft. The timing belt driven by this crankshaft is able to transfer the power to the climate-control compressor. The latter converts the mechanical rotational power into hydraulic power (flow rate and pressure of refrigerant in the gaseous phase), causing the working fluid to heat up. This working fluid is cooled by the condenser which uses the ambient air as its source of cold, and is then expanded through an expander. The fluid thus obtained at low pressure and low temperature evaporates through an exchanger in which the working fluids are glycol water/refrigerant, causing a drop in the temperature of the latter. The system has thus converted kinetic energy into cold energy. During this phase, the fluid in the climate-control loop cools the heat-transfer liquid in the storage heat exchanger. The thermally regenerative braking therefore makes it possible to create a store of energy that can be reused at a later date.

This method also makes it possible to reduce the workload of the brakes and improve the life thereof.

When the vehicle accelerates, the flow rate of circulated gases increases sharply and rapidly, giving rise to a significant increase in the thermal power that has to be removed in order to maintain a constant temperature. During this phase, the controlled valve V1 opens.

The flow rate through the bypass becomes zero and the cold liquid enclosed in the storage exchanger is “driven” into the LT EGR exchanger. This results in an instantaneous drop in temperature of the coolant at constant flow rate. This control makes it possible to minimize or even cancel the increase in temperature of the EGR gases during the transient. The impact is a saving in terms of engine NOx emissions and therefore an increase in the life of the NOx trap and a saving in terms of fuel consumption.

The valve V1 can be controlled in closed-loop control using two thermocouples positioned (Th1) at the outlet of the storage exchanger and (Th2) at the outlet of the LT radiator. The valve is then made to close when the temperatures of Th1 and Th2 are the same.

The valve V1 can be controlled in open-loop control using a state reconstructor based on knowledge of the internal volume of the exchanger, the response time of the valve V1, knowledge of the speed (or voltage) of the pump P1, its pump curves delivery chart=f(pressure drop) and the hydraulic characteristic of the LT circuit (or equivalent cross section). The release time can therefore be estimated using

t(release)=TV1+(volume of STOR. HX)/(Volumetric flow rate of STOR. HX)

(where TV1=response time of valve V1). The volumetric flow rate is then calculated using the hydraulic model of the LT loop by solving the equation

ΔPpump(qvLT)=ΔPLTcircuit(qvLT)′

in the case of a low-temperature water circuit that is separate from the high-temperature water circuit.

To improve on the dynamics and economics, the valve V1 can be controlled using a thermocouple coupled to the state reconstructor.

For better dynamics, phase-advance control may be performed on the valve V1. The on-board processor sends information from the throttle or brake pedal directly to the valve. This valve then benefits from the time taken to transport the gases into the air supply circuit to anticipate the opening thereof and reduce the effect of its response time and of the hydraulic response time.

When the vehicle is under specific engine speed conditions, the hydraulic circuit described hereinabove lends itself to special control strategies.

FIG. 6 illustrates the operation of the hydraulic circuit during a phase in which the engine temperature is increasing. Thus, during a cold start, summer or winter, the thermostat T shuts off access to the radiator and to the degassing bottle. The rise in engine temperature then takes place in two phases:
during the first few minutes (EGR bypass) there is no engine exhaust gas recirculation; to encourage the increase in temperature in the combustion chamber, the recirculated gases are not cooled. During this phase, the electric pump and the continuous supercooling are not switched on. By contrast, regenerative braking using the climate control is switched on and begins to accumulate cold in the storage exchanger.
end of EGR bypass: there is engine exhaust gas recirculation. These exhaust gases are cooled in the HT EGR and the capacitive control is still switched on. Whether or not the electric pump is switched on will essentially depend on the temperature of the HT loop with a view to better-filling performance enhancement.

During this phase, and depending on the climatic conditions, the valve V2 will either allow or not allow the cabin evaporator to operate.

The entire hydraulic circuit may also operate in a heat storage mode: the low-temperature fluid then becomes a high-temperature fluid (R134a from a heat pump for example). FIGS. 8 and 9 illustrate the hydraulic circuit according to the mention coupled to a reversible heat pump air conditioning system:

This architecture involves the incorporation of two additional controlled valves:
the valve V3 that connects the outlet from the combustion engine to the outlet from the ST radiator,
the valve V4 that can be used to reverse the flow in the climate-control loop. This reversal allows the climate-control condenser to become the heat pump evaporator and the two climate-control evaporators to become two heat pump condensers.

The way in which this assembly works in cooling and climate-control mode is illustrated by FIG. 8: the valve V3 is closed. The valve V4 is in direct mode. The way in which the system works is the same as for the basic hydraulic circuit.

The way in which this assembly works in increasing temperature and heat pump mode is illustrated by FIG. 9: The valve V4 is open. The valve V4 is in the reverse mode. The valve V1 is in the release mode. The dead leg between the HT and LT circuits, which initially served merely to impose the reference pressure in the two circuits, becomes a complete line in itself. The storage exchanger receives the heat generated by the heat pump cycle. The water leaving the engine passes through the storage exchanger where it is heated up, then is fed to the oil exchanger, accelerating the increase in temperature of this oil. This architecture makes it possible to reduce the viscosity of the oil, reducing crankshaft friction and improving engine efficiency. The pump P2 can be switched off to minimize electrical power consumption. It can run to improve the effectiveness of the storage exchanger. In hot climates, this architecture can be used exclusively for engine temperature increase with a heat pump efficiency that is very high and therefore an associated additional consumption that is very low.

In cold climates, the heat pump also supplies the unit heater and can be used to heat up the cabin as a supplement to the cabin condenser.

According to one particular embodiment, in the cooling kit, the HtP evaporator is situated in front of the ST radiator. In this case, the air leaving the evaporator has been cooled and impinges on the ST radiator which is full of static water. This radiator then becomes a cold store that can be used right from the start of the cooling phases, thus leaving a delay when switching to climate-control mode for cooling the storage exchanger. Regenerative braking via the climate-control can also be used for cabin temperature.

According to one particular implementation illustrated in FIG. 7, the hydraulic circuit associated with the invention can be produced without an LT radiator:

The LT radiator is omitted. The low-temperature loop is wholly cooled by the air-conditioning system. This solution saves on a radiator, which means that it is possible to increase the size of the condenser and of the HT radiator or to increase the speed of the air passing through these. This solution reduces the thermal inertia of the LT loop.

According to one implementation of the present convention, which is illustrated by FIG. 3, cold can be stored by accumulating liquid water. The principle is to condense the water contained in the intake gases (EGR leg or manifold) and store it in a reservoir, then inject it into a fluid that is to be cooled.

In nominal operation, the recirculated gases are cooled to below their saturation temperature (#60° C.) by supercooled glycol water or a fluid such as R134a. Some of the water contained in the gases condenses and is collected using a phase separator. The liquid water drawn off is then stored in a reservoir. In the context of the present invention, the condensing and collecting devices may be positioned:
on the outlet side of the EGR exchanger,
on the inlet side of the intake manifold.

A valve (electrical or mechanical) between the separator and the reservoir can be used to regulate the water level in the separator and prevent any problem of gas leaking to the reservoir. A calibrated purge valve allows liquid water to be removed from the reservoir in the event of overfilling.

The injection of the water takes place particularly during ascending transient engine speeds: a pump pressurizes the liquid water the flow rate of which is regulated by an injector.

In the case of automotive applications, the injector may be positioned:
in the intake manifold, at the outlet of a CAC and/or at the outlet of an EGR: the issue is then that of controlling the temperature at the manifold by evaporating liquid water. Specifically what happens is that the liquid water injected into the intake gases takes energy away from the intake gases in order to evaporate, reducing the temperature of these gases.
directly in the combustion chamber, which involves incorporating a water injector,
as a premix with the fuel before injecting it.

It is also possible to inject the liquid water upstream of an exchanger in order to flush it so that it maintains its thermal performance.

The hydraulic circuits set out hereinabove can all be applied to the strategy of storing heat energy in the form of liquid water. All that is then required is the addition of a separator downstream of the low-temperature exchanger LT EGR, to collect the condensate.

There are numerous alternative versions of the hydraulic circuit that can be implemented without departing from the scope of the present invention:

In the above description, the LT EGR is cooled to a low or very low temperature. This exchanger may be replaced by:
a low-temperature CAC,
an exchanger on the air intake manifold,
a low-temperature CAC in parallel with an LT EGR,
a normal CAC in parallel with a LT EGR.

All the three-way valves can be replaced by two one-way valves on each of the hydraulic legs.

In the entirety of the above description, cold is stored in the refrigerant/water exchanger. For the purposes of integration into the vehicle, it is also possible for storage to take place in an additional volume positioned at the outlet of the refrigerant/water exchanger, in a volume positioned in the bypass leg.

1-13. (canceled)

14. A motor vehicle comprising:
an internal combustion engine comprising an exhaust gas recirculation circuit, the exhaust gas recirculation circuit comprising a heat exchanger for the recirculated exhaust gases, comprising a high-temperature first stage and a low-temperature second stage;
a first hydraulic circuit for cooling the engine;
a climate-control circuit for air-conditioning the cabin of the vehicle comprising, in a first leg, an evaporator through which a refrigerant circulates;
a second hydraulic circuit for cooling the recirculated gases, comprising a pump driving the coolant of the second hydraulic circuit;
the high-temperature first stage being located in the first hydraulic cooling circuit and the low-temperature second stage being located in the second hydraulic cooling circuit;
a storage heat exchanger allowing an exchange of heat between the coolant of the second hydraulic circuit and the refrigerant of the climate-control circuit;
wherein the second hydraulic circuit comprises a bypass device allowing the coolant of the second hydraulic circuit to bypass the storage heat exchanger; and
wherein the climate-control circuit comprises a second leg, in parallel with the first leg of the evaporator, allowing the refrigerant to circulate through the storage heat exchanger.

15. The vehicle as claimed in claim 14, wherein the bypass device of the second hydraulic cooling circuit comprises a three-way valve.

16. The vehicle as claimed in claim 14, wherein the second hydraulic cooling circuit comprises a radiator for cooling its coolant.

17. The vehicle as claimed in claim 14, wherein the climate-control circuit comprises a three-way valve allowing the refrigerant to enter either the first leg or the second leg.

18. The vehicle as claimed in claim 14, wherein the exhaust gas recirculation circuit comprises, downstream of the heat exchanger, a phase separator, a liquid reservoir, and an injection device capable of reinjecting the liquid into the EGR circuit.

19. The vehicle as claimed in claim 14, wherein the climate-control circuit is a reversible heat pump circuit and comprises a valve for reversing the flow of the fluid, and further comprising an additional valve connecting the outlet from the combustion engine to the outlet from the radiator of the second hydraulic circuit.

20. A method of implementing the vehicle as claimed in claim 14, wherein, at a continuous vehicle combustion engine speed, displacement or rotational speed of the compressor of the climate-control circuit is controlled to optimize a ratio between engine better-filling performance enhancement and energy consumption of the compressor.

21. The method as claimed in claim 20, wherein when the engine better-filling performance enhancement exceeds an additional consumption of the compressor, at a continuous engine speed, the coolant of the second hydraulic circuit circulates through the bypass of the storage heat exchanger so as to store cold in the storage heat exchanger.

22. The method as claimed in claim 20, wherein when the engine better-filling performance enhancement exceeds an additional consumption of the compressor, the recirculated gases are partially condensed in the low-temperature second stage of the exhaust gas heat exchanger, the liquid phase is separated from the gases, and the liquid phase is stored.

23. The method as claimed in claim 20, wherein when the combustion engine is running at a transient engine speed during vehicle braking operations, the displacement or the rotational speed of the compressor of the climate-control circuit is maximized, and the coolant of the second hydraulic circuit circulates through the bypass of the storage heat exchanger so as to accumulate cold in the storage heat exchanger.

24. The method as claimed in claim 20, wherein when the combustion engine is running at an ascending transient engine speed, or during vehicle accelerations, the bypass of the storage heat exchanger is closed, and the coolant of the second hydraulic circuit circulates through the storage heat exchanger so as to expel the cold liquid from the storage heat exchanger.

25. The method as claimed in claim 22, wherein when the combustion engine is running at an ascending transient engine speed, or during vehicle accelerations, the stored liquid phase is reinjected into the intake gases.

26. The method as claimed in claim 25, wherein the liquid phase is reinjected at a point chosen from:
an intake manifold,
a combustion chamber,
a point upstream of a fuel injector, or
a point upstream of an exchanger.
